(19) United States
(12) Patent Application Publication
(10) Pub. No.: US 2018/0146404 A1
(43) Pub. Date: May 24, 2018

(54) MINIMIZED SYSTEM INFORMATION TRANSMISSION IN WIRELESS COMMUNICATION SYSTEMS

(71) Applicant: Intel IP Corporation, Santa Clara, CA (US)

(72) Inventors: Yujian Zhang, Beijing (CN); Mo-Han Fong, Sunnyvale, CA (US); Ralf Matthias Bendlin, Portland, OR (US)

(21) Appl. No.: 15/571,614

(22) PCT Filed: Dec. 23, 2015
(86) PCT No.: PCT/US2015/000249

§ 371 Date: Nov. 3, 2017

Related U.S. Application Data
(60) Provisional application No. 62/168,469, filed on May 29, 2015.

(51) Int. Cl. H04W 36/04; H04W 48/12; H04W 48/10; H04W 72/04

(52) U.S. Cl. CPC H04W 36/04; H04W 48/12; H04W 88/06; H04W 72/044; H04J 2211/003; H04W 48/10

(57) ABSTRACT

The periodic broadcasting of system information by an eNB is costly in terms of both spectrum and energy. Embodiments described herein more efficiently transmit system information and are particularly applicable to 5G deployment scenarios. In one embodiment, an LTE cell broadcasts system information to be used by a UE in initially connecting to a 5G cell, termed initial access system information. The 5G cell may then transmit system information upon request by a connected UE or when the system information is updated.

### PRIORITY CLAIM

This application claims priority to U.S. Provisional Patent Application Ser. No. 62/168,469, filed May 29, 2015, which is incorporated herein by reference in its entirety

### TECHNICAL FIELD

Embodiments described herein relate generally to wireless networks and communications systems. Some embodiments relate to cellular communication networks including 3GPP (Third Generation Partnership Project) networks, 3GPP LTE (Long Term Evolution) networks, and 3GPP LTE-A (LTE Advanced) networks, although the scope of the embodiments is not limited in this respect.

### BACKGROUND

In LTE (Long Term Evolution) cellular systems, as set forth in the LTE specifications of the 3rd Generation Partnership Project (3GPP), mobile terminals (where a terminal is referred to in LTE systems as user equipment or UE) connect to a base station (referred in LTE systems as an evolved Node B or eNB) that provides connectivity for the UE to other network entities of the LTE system that connect to an external network such as the internet. The fifth generation (5G) of mobile technology is intended to enable connectivity for a wide range of new applications and use cases by providing improvements in data rates, latency, and reliability. An objective of the present disclosure is to increase spectral and energy efficiency by minimizing system information transmission.

### BRIEF DESCRIPTION OF THE DRAWINGS

FIG. 1 illustrates an example UE and eNB according to some embodiments.

FIG. 2 illustrates a procedure by which a UE connects to a 5G cell according to some embodiments

FIG. 3 illustrates transmission of system information by LTE and 5G cells according to some embodiments.

FIG. 4 illustrates an example of a user equipment device according to some embodiments.

FIG. 5 illustrates an example of a computing machine according to some embodiments.

### DETAILED DESCRIPTION

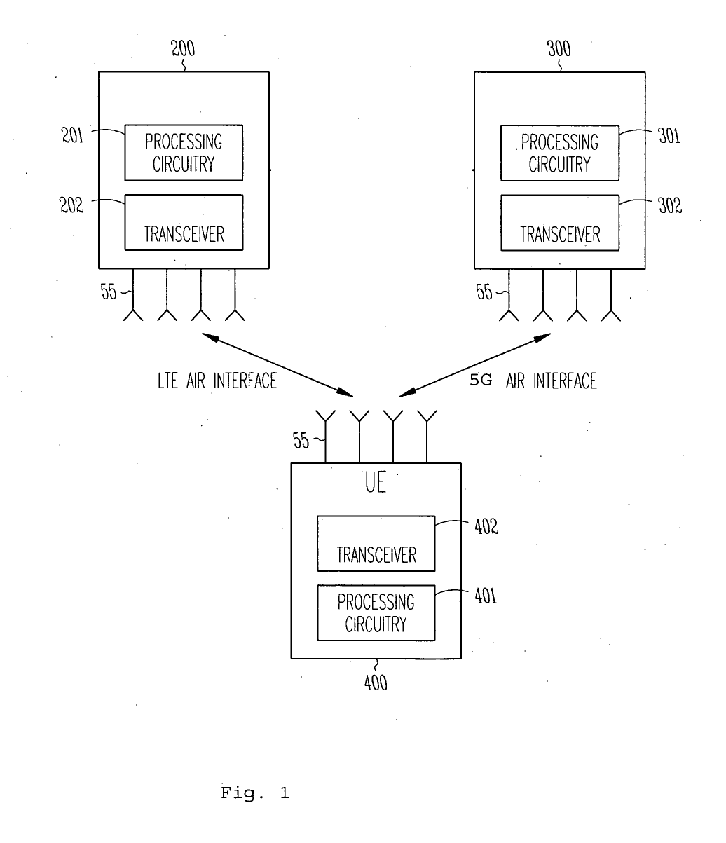

An eNB provides an RF (radio frequency communications link for a UE, sometimes referred to as a radio or air interface. An eNB may provide a plurality of air interfaces, sometimes referred to as cells, where each cell operates a particular carrier frequency and covers a particular geographic area. A UE communicates with one eNB at a time and, as the UE moves, may switch to another eNB or another cell in a procedure known as handover. The eNB provides uplink and downlink data channels for all of the UEs in its cells and relays data traffic between the UE and the EPC (evolved packet core), the latter providing connectivity to external networks such as the Internet. When a UE is connected to particular cell, that cell is termed the UE's serving cell. FIG. 1 illustrates an example of the components of a UE 400, an eNB 200, and an eNB 300. The UE 400 includes processing circuitry 401 connected to a radio transceiver for providing an LTE air interface and/or a 5G air interface. The eNB 200 includes processing circuitry 201 connected to a transceiver 202 for providing an LTE interface. The eNB 300 includes processing circuitry 301 connected to a transceiver 302 for providing a 5G interface. The transceivers in each the devices are connected to antennas 55.

In the embodiments described herein, an eNB may provide a plurality of cells using different transmission points (TPs). LTE and 5G cells, for example, may be provided by separate eNBs as shown in FIG. 1 or by a single eNB. It should be mentioned that the term cell is sometimes used to refer to the geographic area served by a particular eNB and to particular carrier frequencies used by an eNB operating with carrier aggregation (CA) where those carrier frequencies are referred to as primary cells (PCells) or secondary cells (SCells). The term cell as used in this disclosure, however, should be taken to refer to a particular LTE or 5G air interface unless the context indicates otherwise.

When a UE is connected to an eNB as its serving cell, the UE is said to be in an RRC_CONNECTED state, referring to the Radio Resource Control (RRC) protocol which is the topmost control-plane layer of the LTE radio access protocol stack in the eNB. In order to establish an RRC connection with an eNB, the UE utilizes system information broadcast by the eNB in order to set up SRBs (signaling radio bearers, moving from what is called RRC_IDLE state to RRC_CONNECTED state. The UE may subsequently connect itself to the EPC and acquire network connectivity by registering with the MME (mobility management entity) of the EPC using an attach procedure via the NAS (non-access stratum) protocol layer present in UE and the MME. The process by which a UE establishes an RRC connection with an eNB is referred to herein as initial access, and the system information used for this purpose is referred to as initial access system information. Other system information broadcast or otherwise transmitted by an eNB is referred to as non-initial access system information.

LTE cells broadcast RRC system information messages that indicate how the cell has been configured. The system information is organized into a master information block (MIB) and into several numbered system information blocks (e.g., SIB1, SIB2 . . . SIB16 in Release 11 of the LTE specifications). SIB 1 defines the way in which the other system information blocks will be scheduled and also includes the parameters that the UE uses for network and cell selection such as the tracking area code and a list of networks that the cell belongs to. SIB 2 includes parameters that describe the cell's radio resources and physical channels, such as the power that the eNB is transmitting its downlink reference signals (RSs).

In current LTE systems, system information (SI) may be transmitted by an eNB a number of times with the same content within a modification period, no matter whether the UE is receiving or not. How frequently the system information blocks (SIBs) are transmitted is a tradeoff between overhead and access time. One of the SIBs, SIB1, is transmitted every 20 ms. Other SIBs are scheduled by SIB1 and may be transmitted with different periodicities. The problem with this legacy system information transmission scheme is that the periodic transmission consumes radio resources and causes interference. In addition, even if there are no users camped in the cell, the system information is still transmitted which is not energy efficient. Embodiments described herein more efficiently transmit system information and are particularly applicable to 5G deployment scenarios.

System information can be categorized as being either initial access system information or non-initial access system information. In LTE, initial access system information is used for initial access and is transmitted to the UE in the following information blocks:
1) MIB: includes DL (downlink) bandwidth, number of DL antenna ports, PHICH (physical hybrid automatic repeat request channel) configuration and System Frame Number (SFN)
2) SIB1: includes cell access related information (e.g. PLMN (public land mobile network) identity list, tracking area code, cell identity, barred cell indication, intra-frequency reselection allowed, CSG (closed subscriber group) information), cell selection information, frequency band indicator, and scheduling information for other SIBs.
3) SIB2: includes configuration information for RACH (random access channel)/BCCH (broadcast control channel)/paging, common configuration for PDSCH (physical downlink shared channel)/PUSCH (physical uplink shared channel)/PUCCH (physical uplink control channel)/SRS (sounding reference signal)/power control, UL (uplink) CP (cyclic prefix) length, timers and constants, frequency information (UL carrier frequency, bandwidth, additional spectrum emission), MBSFN (nulticast-broadcast single frequency network) subframe configuration, and time alignment timer.

Only after the UE acquires MIB, SIB1, and SIB2 is the UE able to initiate a random access procedure for connecting to the eNB and subsequently attaching to the network. Non-initial access system information is the information not used for initial access and would include, for example, information relating to cell reselection, configuration for MBMS (multimedia broadcast-multicast service), and information relating D2D (device-to-device) communications.

System information can be also categorized as being system-wide information or cell-specific information. System-wide information may be the same across all the cells. For example, the public land mobile network PLMN (public land mobile network) identity is the same for all the cells that belong to the same operator network. Some radio configurations could also be set to be the same across the network. On the other hand, some information is unique to each cell and therefore cell-specific. For example, access barring information is mostly cell specific. Other examples are the downlink reference signals whose transmission powers are used for open loop power control. These transmission powers depend on the base station type. Typically, the larger the coverage of the cell, the higher is the transmission power.

In legacy LTE systems, both system-wide and cell-specific information are transmitted, but there is no clear distinction on which information elements (IEs) are system-wide and which IEs are cell-specific. In addition, in one particular cell, the transmitted system information may not contain cell-specific information of other cells. Therefore, if a UE camps on a different cell (e.g., after cell reselection or after radio link failure (RLF)), the UE needs to acquire the system information for that cell.

In some embodiments herein, the system information transmitted by a serving cell includes both system-wide information and cell-specific information pertaining to a group of cells, which group includes the serving cell. In this approach, all cells in one particular area may transmit the same system information. Such an approach may be applied to initial access system information and/or to non-initial access system information. In one embodiment, for initial access system information, a cell broadcasts system-wide information and cell-specific information for a group of cells. For non-initial access system information, the serving cell only broadcasts system-wide information and cell-specific information for the serving cell. To save signaling overhead, cell-specific system information may be grouped with the grouping based on, for example, carrier frequency or cell identities. Described below are different embodiments for organizing system information. In these embodiments, system information may be transmitted in different messages as done in LTE currently (i.e., different SIBs to carry different content) or in one message containing all the system information to be transmitted.

In one embodiment, cell specific information is given in the message for each cell of a group explicitly. Each cell may be designated in the message by one or any combination of frequency, physical cell identity (PCI), or other identifiers that could uniquely identify a cell. The message or messages would then include the following information for a group of n cells:
System-wide information
Cell 1: cell-specific information
Cell 2: cell-specific information
.
.
Cell n: cell specific information

In another embodiment, cell-specific information is given for n frequency lists that each list the cells operating at a particular carrier frequency and have the same cell-specific information. The message or messages would then include the following information for n frequency lists:
System-wide information
Frequency list 1: cell-specific information
Frequency list 2: cell-specific information
.
.
Frequency list n: cell-specific information

In another embodiment, cell-specific information is listed for each one of n cell ID lists. A cell ID list could be an explicit list of cell IDs or a range of cell IDs (e.g. with a starting cell ID and an ending cell ID) where the cell-specific information of the cells in the same cell ID list is the same. The message or messages would then include the following information for n cell ID lists:
System-wide information
Cell ID list 1: cell-specific information
Cell ID list 2: cell-specific information
.
.
Cell ID list n: cell-specific information

In some embodiments, initial access system information of 5G systems is transmitted by an LTE cell by broadcasting or by providing the information via dedicated RRC signaling. For the broadcast approach, one or more new LTE SIBs may be used to broadcast initial access system information of 5G systems. One way to reduce signaling overhead is to only broadcast 5G initial access system information in a subset of LTE carriers. For those LTE carriers not providing such information, they can provide a frequency list to guide UE to carriers that do provide the information. Such a frequency list may be contained in an existing SIB defined in the LTE specifications or a new SIB.

For the dedicated RRC signaling approach, the UE can first camp on the LTE cell and then initiate a random access procedure in the LTE cell. After establishing an RRC connection in LTE, the UE initiates the procedure to request 5G initial access system information. After acquiring the information, the UE can then release the RRC connection in LTE. Note that UE may also perform NAS (non-access stratum) procedures in LTE such attach and detach. After the UE acquires initial access system information for the 5G cell from the LTE cell, the UE can then perform cell selection in 5G and acquire other system information.

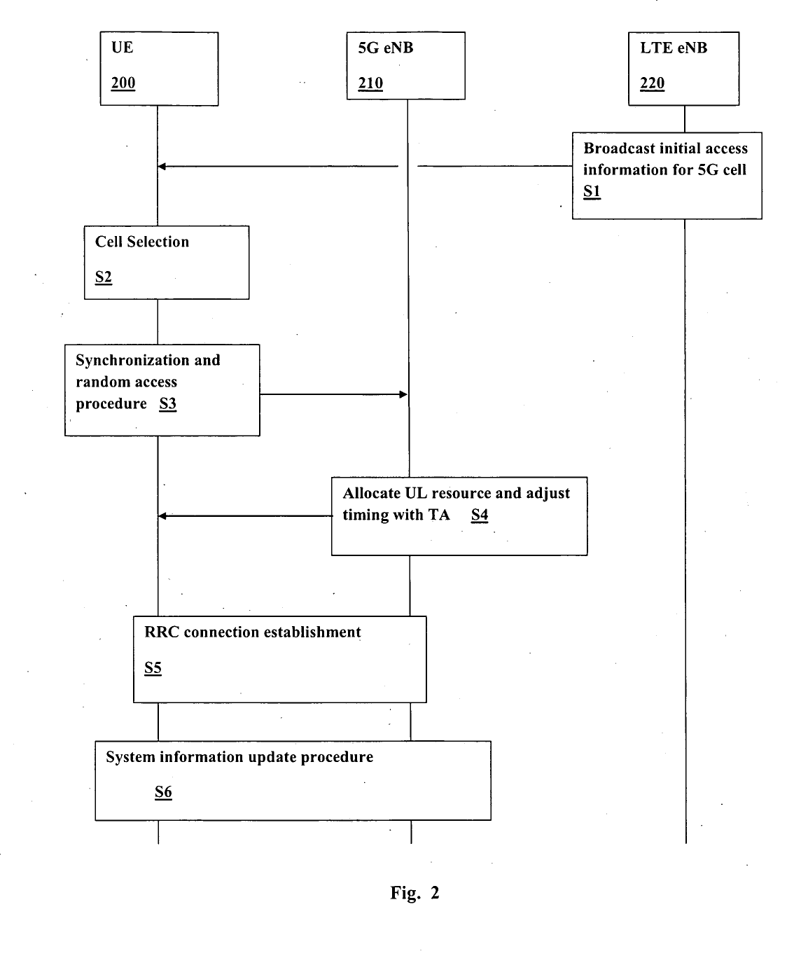

FIG. 2 illustrates how a UE acquires 5G system information when 5G initial access system information is broadcast in LTE according to one embodiment. At stage S1, the UE acquires 5G initial access system information (e.g., MIB, SIB1, and SIB2) from the LTE cell via broadcast. At stage S2, the UE performs cell selection for the 5G cell. At stage S3, the UE initiates a random access procedure for the 5G cell using the received initial access system information. At stage S4, the 5G eNB allocates UL resources to the UE and adjusts the uplink transmission timing. At stage S5, the UE performs the RRC connection establishment procedure and also may perform an initial attach procedure in the NAS layer. The UE may also request non-initial access system information from the network, e.g. via dedicated RRC signaling. At stage, S6 the UE performs a system information update procedure with the 5G cell as discussed below.

There could be several options as to how UE may acquire non-initial access system information. One option is that eNB provides UE non-initial access system information based on a UE capability report. For example, the eNB may provide UMTS (Universal Mobile Telecommunications System) related cell reselection information for a UE with UMTS capability. Similarly, the eNB may provide D2D system information to a UE with D2D capability. Another option is that UE explicitly lists the SIBs it want to acquire, and eNB provides the SIBs accordingly.

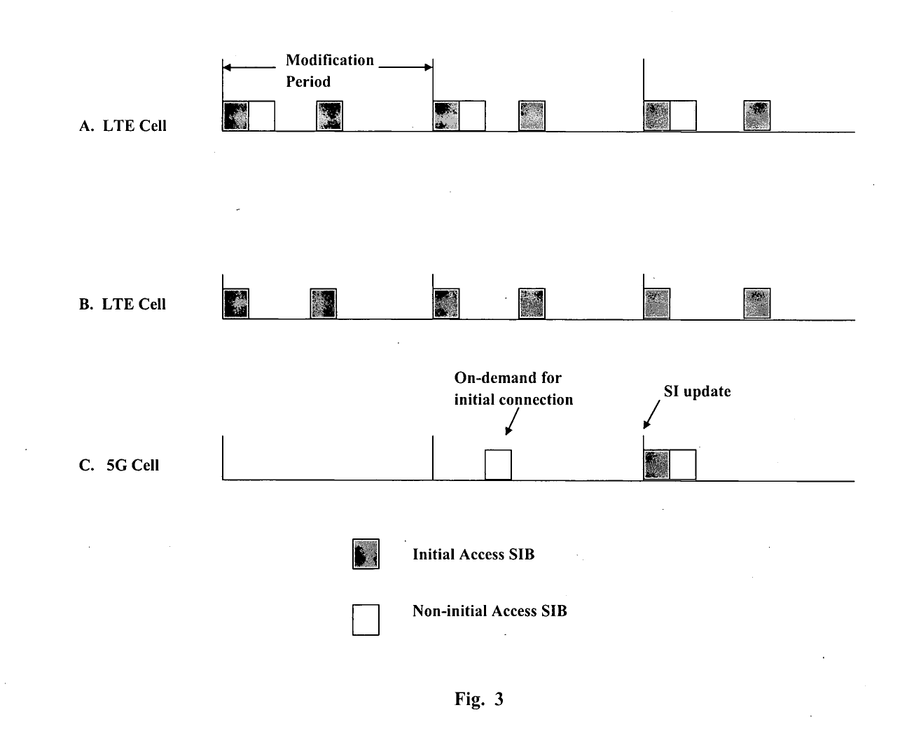

FIG. 3 illustrates in timelines labeled A, B, and C the transmission of initial access and non-initial access system information by LTE and 5G cells according to some embodiments. In the embodiment with timeline A, an LTE cell periodically broadcasts both initial access and non-initial access system information at periods equal to what is called the modification period. In another embodiment, timeline B shows an LTE cell broadcasting only initial access system information for the 5G cell every modification period. Timeline C shows the 5G cell transmitting non-essential system information to a connected UE upon request by the UE and transmitting both initial access and non-initial access system information at a modification period boundary when the information needs to be updated. In current LTE, for a camped cell in RRC_IDLE state, the UE checks whether system information has been updated either based on the systemInfoValueTag in SIB1 or a systemInfoModification message transmitted in the previous modification period during paging. In one embodiment, a 5G cell may page the UE if system information will be changed, and updated system information is then broadcasted, where the broadcasted information may include initial access and/or non-initial access system information.

After cell reselection or RLF (radio link failure), the UE only has to reacquire system information if that information has been changed since it was last acquired. Assuming the network has a common modification period which is aligned among all cells, the SI acquisition procedure for cell-reselection/RLF operation may then be similar for the SI update procedure. If the UE performs cell re-selection or RRC connection re-establishment at a modification period boundary, the UE checks whether system information has changed or not and re-acquires the system information if necessary from the target cell. Otherwise, the UE does not need to reacquire system information as it already knows the system information of the target cell. Note that the above discussion assumes that non-initial access system information of other cells is also transmitted by the source cell. If that is not the case, UE may need to initiate a procedure to acquire non-initial access system information. The procedure would then be similar to the procedure for initial access.

In current LTE, once a UE acquires updated system information, it uses it immediately. There could, however, be some time of service interruption in this situation because the updated SIB is transmitted at the beginning of the corresponding modification period. Some configuration information might then be wrong before UE actually acquires the new SIB. One way to reduce the interruption time is to transmit updated system information in the previous modification period. Once the UE acquires the updated system information, it would then only apply the updated system information at the start of the next system information modification period.

The transmission of identical time-aligned signals from multiple cells, especially in the case of broadcast/multicast services, is sometimes referred to as Single-Frequency Network (SFN) operation. Since system information includes both system wide information and cell specific information of a group of cells, SFN can be used for all cells in the group. With the usage of SFN, the resource needed for system information transmission can be greatly reduced due to SFN combining gain.

### Example UE Description

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

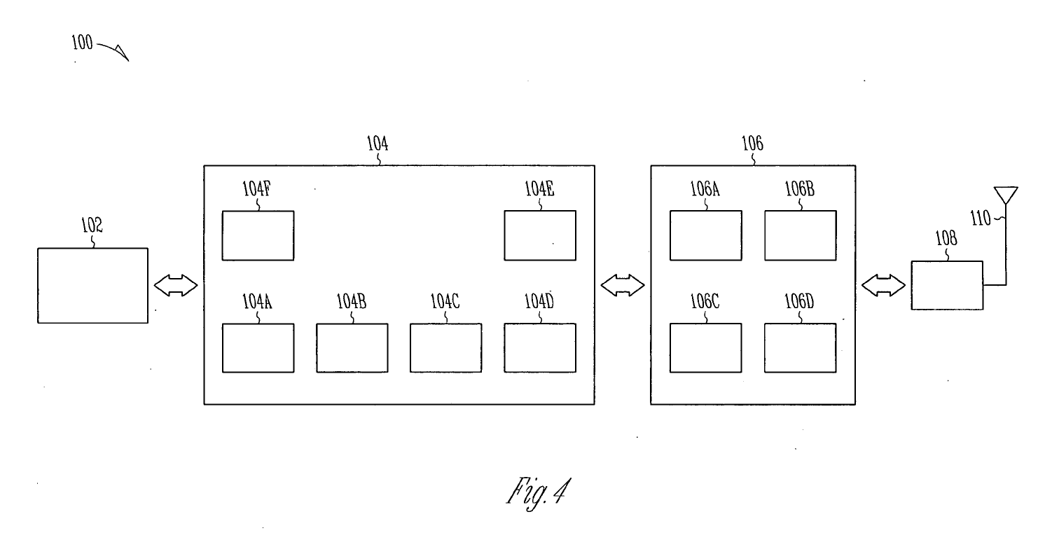

Embodiments described herein may be implemented into a system using any suitably configured hardware and/or software. FIG. 4 illustrates, for one embodiment, example components of a User Equipment (UE) device 100. In some embodiments, the UE device 100 may include application circuitry 102, baseband circuitry 104, Radio Frequency (RF) circuitry 106, front-end module (FEM) circuitry 108 and one or more antennas 110, coupled together at least as shown.

The application circuitry 102 may include one or more application processors. For example, the application circuitry 102 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 104 may include circuitry such as, but not limited to, one or more single-core or multi-core processors. The baseband circuitry 104 may include one or more baseband processors and/or control logic to process baseband signals received from a receive signal path of the RF circuitry 106 and to generate baseband signals for a transmit signal path of the RF circuitry 106. Baseband processing circuitry 104 may interface with the application circuitry 102 for generation and processing of the baseband signals and for controlling operations of the RF circuitry 106. For example, in some embodiments, the baseband circuitry 104 may include a second generation (2G) baseband processor 104a, third generation (3G) baseband processor 104b, fourth generation (4G) baseband processor 104c, and/or other baseband processor(s) 104d for other existing generations, generations in development or to be developed in the future (e.g., fifth generation (5G), 6G, etc.). The baseband circuitry 104 (e.g., one or more of baseband processors 104a-d) may handle various radio control functions that enable communication with one or more radio networks via the RF circuitry 106. The radio control functions may include, but are not limited to, signal modulation/demodulation, encoding/decoding, radio frequency shifting, etc. In some embodiments, modulation/demodulation circuitry of the baseband circuitry 104 may include Fast-Fourier Transform (FFT), precoding, and/or constellation mapping/demapping functionality. In some embodiments, encoding/decoding circuitry of the baseband circuitry 104 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 104 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 104e of the baseband circuitry 104 may be configured to run elements of the protocol stack for signaling of the PHY, MAC, RLC, PDCP and/or RRC layers. In some embodiments, the baseband circuitry may include one or more audio digital signal processor(s) (DSP) 104f. The audio DSP(s) 104f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 104 and the application circuitry 102 may be implemented together such as, for example, on a system on a chip (SOC).

In some embodiments, the baseband circuitry 104 may provide for communication compatible with one or more radio technologies. For example, in some embodiments, the baseband circuitry 104 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 104 is configured to support radio communications of more than one wireless protocol may be referred to as multi-mode baseband circuitry.

RF circuitry 106 may enable communication with wireless networks using modulated electromagnetic radiation through a non-solid medium. In various embodiments, the RF circuitry 106 may include switches, filters, amplifiers, etc. to facilitate the communication with the wireless network. RF circuitry 106 may include a receive signal path which may include circuitry to down-convert RF signals received from the FEM circuitry 108 and provide baseband signals to the baseband circuitry 104. RF circuitry 106 may also include a transmit signal path which may include circuitry to up-convert baseband signals provided by the baseband circuitry 104 and provide RF output signals to the FEM circuitry 108 for transmission.

In some embodiments, the RF circuitry 106 may include a receive signal path and a transmit signal path. The receive signal path of the RF circuitry 106 may include mixer circuitry 106a, amplifier circuitry 106b and filter circuitry 106c. The transmit signal path of the RF circuitry 106 may include filter circuitry 106c and mixer circuitry 106a. RF circuitry 106 may also include synthesizer circuitry 106d for synthesizing a frequency for use by the mixer circuitry 106a of the receive signal path and the transmit signal path. In some embodiments, the mixer circuitry 106a of the receive signal path may be configured to down-convert RF signals received from the FEM circuitry 108 based on the synthesized frequency provided by synthesizer circuitry 106d. The amplifier circuitry 106b may be configured to amplify the down-converted signals and the filter circuitry 106c may be a low-pass filter (LPF) or band-pass filter (BPF) configured to remove unwanted signals from the down-converted signals to generate output baseband signals. Output baseband signals may be provided to the baseband circuitry 104 for further, processing. In some embodiments, the output baseband signals may be zero-frequency baseband signals, although this is not a requirement. In some embodiments, mixer circuitry 106a of the receive signal path may comprise passive mixers, although the scope of the embodiments is not limited in this respect.

In some embodiments, the mixer circuitry 106a of the transmit signal path may be configured to up-convert input baseband signals based on the synthesized frequency provided by the synthesizer circuitry 106d to generate RF output signals for the FEM circuitry 108. The baseband signals may be provided by the baseband circuitry 104 and may be filtered by filter circuitry 106c. The filter circuitry 106c may include a low-pass filter (LPF), although the scope of the embodiments is not limited in this respect.

In some embodiments, the mixer circuitry 106a of the receive signal path and the mixer circuitry 106a of the transmit signal path may include two or more mixers and may be arranged for quadrature downconversion and/or upconversion respectively. In some embodiments, the mixer circuitry 106a of the receive signal path and the mixer circuitry 106a of the transmit signal path may include two or more mixers and may be arranged for image rejection (e.g., Hartley image rejection). In some embodiments, the mixer circuitry 106a of the receive signal path and the mixer circuitry 106a may be arranged for direct downconversion and/or direct upconversion, respectively. In some embodiments, the mixer circuitry 106a of the receive signal path and the mixer circuitry 106a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 106 may include analog-to-digital converter (ADC) and digital-to-analog converter (DAC) circuitry and the baseband circuitry 104 may include a digital baseband interface to communicate with the RF circuitry 106.

In some dual-mode embodiments, a separate radio IC circuitry may be provided for processing signals for each spectrum, although the scope of the embodiments is not limited in this respect.

In some embodiments, the synthesizer circuitry 106d may be a fractional-N synthesizer or a fractional N/N+1 synthesizer, although the scope of the embodiments is not limited in this respect as other types of frequency synthesizers may be suitable. For example, synthesizer circuitry 106d may be a delta-sigma synthesizer, a frequency multiplier, or a synthesizer comprising a phase-locked loop with a frequency divider.

The synthesizer circuitry 106d may be configured to synthesize an output frequency for use by the mixer circuitry 106a of the RF circuitry 106 based on a frequency input and a divider control input. In some embodiments, the synthesizer circuitry 106d may be a fractional N/N+1 synthesizer.

In some embodiments, frequency input may be provided by a voltage controlled oscillator (VCO), although that is not a requirement. Divider control input may be provided by either the baseband circuitry 104 or the applications processor 102 depending on the desired output frequency. In some embodiments, a divider control input (e.g., N) may be determined from a look-up table based on a channel indicated by the applications processor 102.

Synthesizer circuitry 106d of the RF circuitry 106 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 106d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 106 may include an IQ/polar converter.

FEM circuitry 108 may include a receive signal path which may include circuitry configured to operate on RF signals received from one or more antennas 110, amplify the received signals and provide the amplified versions of the received signals to the RF circuitry 106 for further processing. FEM circuitry 108 may also include a transmit signal path which may include circuitry configured to amplify signals for transmission provided by the RF circuitry 106 for transmission by one or more of the one or more antennas 110.

In some embodiments, the FEM circuitry 108 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 106). The transmit signal path of the FEM circuitry 108 may include a power amplifier (PA) to amplify input RF signals (e.g., provided by RF circuitry 106), and one or more filters to generate RF signals for subsequent transmission (e.g., by one or more of the one or more antennas 110.

In some embodiments, the UE device 100 may include additional elements such as, for example, memory/storage, display, camera, sensor, and/or input/output (I/O) interface.

### Example Machine Description

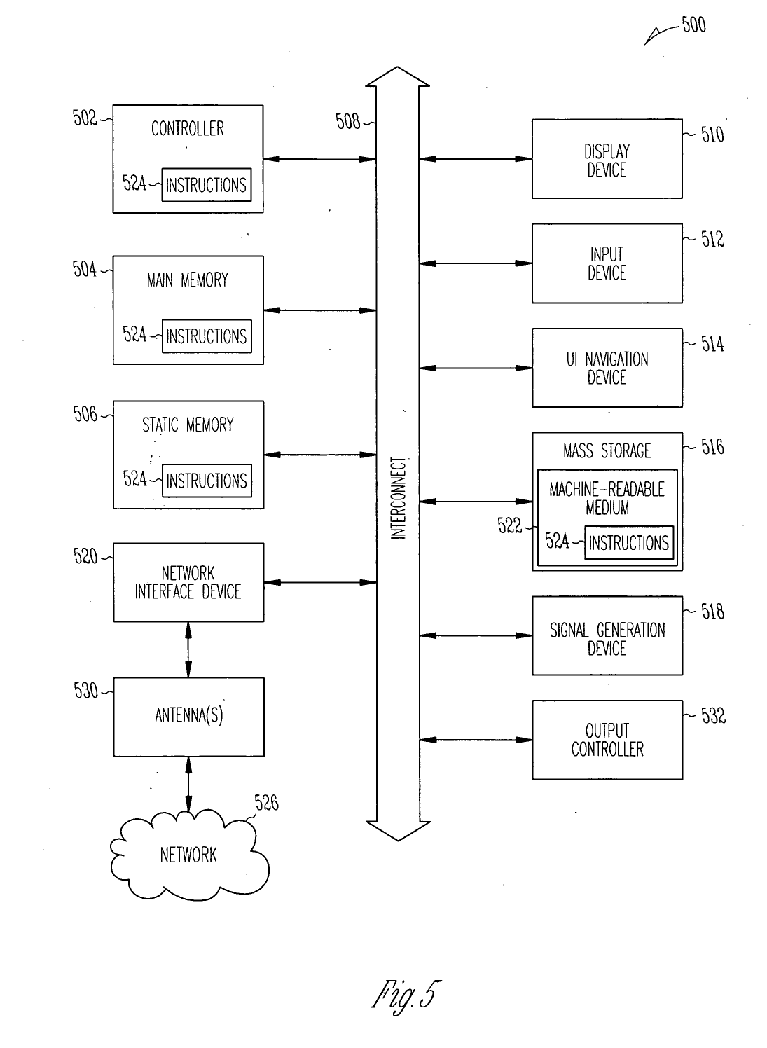

FIG. 5 illustrates a block diagram of an example machine 500 upon which any one or more of the techniques (e.g., methodologies) discussed herein may perform. In alternative embodiments, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a user equipment (UE), evolved Node B (eNB), Wi-Fi access point (AP), Wi-Fi station (STA), personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term “machine readable medium” may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques. The term “transmission medium” shall be taken to include any intangible medium that is capable of storing, encoding or carrying instructions for execution by the machine 500, and includes digital or analog communications signals or other intangible medium to facilitate communication of such software.

### Additional Notes and Examples

In Example 1, an apparatus for a UE (user equipment), comprises: a radio transceiver and processing circuitry interfaced to the radio transceiver; wherein the transceiver is to receive system information transmitted by an LTE (Long Term Evolution) cell, which system information comprises LTE initial access system information for connecting to the LTE cell and 5G (fifth generation) initial access system information for connecting to a 5G cell using random access procedures; and, wherein the processing circuitry and transceiver are to connect to the 5G cell using the initial access system information received from the LTE cell.

In Example 2, the subject matter of Example 1 or any of the Examples herein may further include wherein the processing circuitry and transceiver are to receive the 5G initial access system information for connecting to the 5G cell via an SIB (system information block) broadcasted by the LTE cell.

In Example 3, the subject matter of Example 1 or any of the Examples herein may further include wherein the processing circuitry and transceiver are to receive the 5G initial access system information for connecting to the 5G cell by establishing an RRC (radio resource control) connection with the LTE cell and requesting information for connecting to the 5G cell via RRC signaling.

In Example 4, the subject matter of Example 1 or any of the Examples herein may further include wherein the 5G and LTE initial access system information received from the LTE cell includes an MIB (master information block) containing information that includes a DL (downlink) cell bandwidth and control channel configurations, an SIB1 (system information block 1) containing information that includes information relating to access restrictions and time-domain scheduling of an SIB2 (system information block 2) that includes information relating to random access procedures for connecting to the cell.

In Example 5, the subject matter of Example 1 or any of the Examples herein may further include wherein the system information received from the LTE cell further comprises system-wide information that is common to a plurality of neighboring LTE and/or 5G cells.

In Example 6, the subject matter of Example 1 or any of the Examples herein may further include wherein the system information received from the LTE cell further comprises cell-specific information for a group of LTE and/or 5G cells contained within a cell group.

In Example 7, the subject matter of Example 6 or any of the Examples herein may further include wherein the cell-specific information includes initial access information for connecting to each cell within the cell group.

In Example 8, the subject matter of Example 6 or any of the Examples herein may further include wherein the cell-specific information comprises a cell ID (identification) for each cell within the cell group and cell-specific information associated with each cell ID.

In Example 9, the subject matter of Example 6 or any of the Examples herein may further include wherein the cell-specific information comprises one or more lists of cell IDs (identifications) and cell-specific information associated with each list.

In Example 10, the subject matter of Example 6 or any of the Examples herein may further include wherein the cell-specific information comprises one or more lists of carrier frequencies and cell-specific information associated with each list.

In Example 11, the subject matter of Example 1 or any of the Examples herein may further include wherein the processing circuitry and transceiver are to receive updated system information from the LTE or 5G cell but not apply the updated system information until the start of a next system information modification period.

In Example 12, an apparatus for an eNB (evolved Node B), comprises: a radio transceiver and processing circuitry interfaced to the radio transceiver; wherein the processing circuitry and transceiver are to: transmit system information over a cell served by the eNB; wherein the system information transmitted over the serving cell further comprises system-wide information that is common to a plurality of neighboring cells and cell-specific information for a group of cells contained within a cell group; and, wherein the cell-specific information for at least two of the cells in the cell group is different.

In Example 13, the subject matter of Example 12 or any of the Examples herein may further include wherein the cell-specific information comprises a cell ID (identification) for each cell within the cell group and cell-specific information associated with each cell ID.

In Example 14, the subject matter of Example 12 or any of the Examples herein may further include wherein the cell-specific information comprises one or more lists of cell IDs (identifications) and cell-specific information associated with each list.

In Example 15, the subject matter of Example 1 or any of the Examples herein may further include wherein the cell-specific information comprises one or more lists of carrier frequencies and cell-specific information associated with each list.

In Example 16, the subject matter of Example 12 or any of the Examples herein may further include wherein the cell-specific information includes initial access system information for connecting to each cell within the cell group using a random access procedure.

In Example 17, the subject matter of Example 16 or any of the Examples herein may further include wherein at least one of cells in the group for which initial access system information is transmitted is a 5G (fifth generation) cell.

In Example 18, the subject matter of Example 12 or any of the Examples herein may further include wherein the processing circuitry and transceiver are to transmit the initial access information for connecting to the 5G cell via a broadcasted SIB (system information block) or via RRC (radio resource control) after a UE connects with a serving cell of the eNB.

In Example 19, the subject matter of Example 12 or any of the Examples herein may further include wherein the transmitted initial access information includes an MIB (master information block) containing information that includes a DL (downlink) cell bandwidth and control channel configurations, an SIB1 (system information block 1) containing information that includes information relating to access restrictions and time-domain scheduling of an SIB2 (system information block 2).

In Example 20, an apparatus for an eNB (evolved Node B), comprises: a radio transceiver and processing circuitry interfaced to the radio transceiver; wherein the processing circuitry and transceiver are to: transmit system information over an LTE (Long Term Evolution) cell served by the eNB; wherein the system information transmitted over the LTE serving cell further comprises system-wide information that is common to a plurality of neighboring LTE and/or 5G cells and cell-specific information for a group of LTE and/or 5G cells contained within a cell group.

In Example 21, a transitory or non-transitory computer-readable medium comprises instructions to cause a user equipment (UE), upon execution of the instructions by processing circuitry of the UE, to perform any of the functions described in Examples 1 through 11.

In Example 22, a transitory or non-transitory computer-readable medium comprises instructions to cause an evolved Node B (eNB) upon execution of the instructions by processing circuitry of the eNB, to perform any of the functions described in Examples 12 through 20.

In Example 23, a method for operating a UE comprises means for performing any of the functions described in Examples 1 through 11.

In Example 24, a method for operating an eNB comprises means for performing any of the functions described in Examples 12 through 20.

In Example 25, a method for operating a UE comprises performing any of the functions described in Examples 1 through 11.

In Example 26, a method for operating an eNB comprises performing any of the functions described in Examples 12 through 20.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the invention is not limited in this respect. An example LTE system includes a number of mobile stations, defined by the LTE specification as User Equipment (UE), communicating with a base station, defined by the LTE specifications as an eNB.

Antennas referred to herein may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

In some embodiments, a receiver as described herein may be configured to receive signals in accordance with specific communication standards, such as the Institute of Electrical and Electronics Engineers (IEEE) standards including IEEE 802.11 standards and/or proposed specifications for WLANs, although the scope of the invention is not limited in this respect as they may also be suitable to transmit and/or receive communications in accordance with other techniques and standards. In some embodiments, the receiver may be configured to receive signals in accordance with the IEEE 802.16-2004, the IEEE 802.16(e) and/or IEEE 802.16(m) standards for wireless metropolitan area networks (WMANs) including variations and evolutions thereof, although the scope of the invention is not limited in this respect as they may also be suitable to transmit and/or receive communications in accordance with other techniques and standards. In some embodiments, the receiver may be configured to receive signals in accordance with the Universal Terrestrial Radio Access Network (UTRAN) LTE communication standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” May 2005 and related amendments/versions. For more information with respect to UTRAN LTE standards, see the 3rd Generation Partnership Project (3GPP) standards for UTRAN-LTE, including variations and evolutions thereof.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1-25. (canceled)

26. An apparatus for a UE (user equipment), comprising:
a radio transceiver and processing circuitry interfaced to the radio transceiver;
wherein the transceiver is to receive system information transmitted by an LTE (Long Term Evolution) cell, which system information comprises LTE initial access system information for connecting to the LTE cell and 5G (fifth generation) initial access system information for connecting to a 5G cell using random access procedures; and,
wherein the processing circuitry and transceiver are to connect to the 5G cell using the initial access system information received from the LTE cell.

27. The apparatus of claim 26 wherein the processing circuitry and transceiver are to receive the 5G initial access information for connecting to the 5G cell via an SIB (system information block) broadcasted by the LTE cell.

28. The apparatus of claim 26 wherein the processing circuitry and transceiver are to receive the 5G initial access information for connecting to the 5G cell by establishing an RRC (radio resource control) connection with the LTE cell and requesting information for connecting to the 5G cell via RRC signaling.

29. The apparatus of claim 26 wherein the 5G and LTE initial access information received from the LTE cell includes an MIB (master information block) containing information that includes a DL (downlink) cell bandwidth and control channel configurations, an SIB1 (system information block 1) containing information that includes information relating to access restrictions and time-domain scheduling of an SIB2 (system information block 2) that includes information relating to random access procedures for connecting to the cell.

30. The apparatus of claim 26 wherein the system information received from the LTE cell further comprises system-wide information that is common to a plurality of neighboring LTE and/or 5G cells.

31. The apparatus of claim 26 wherein the system information received from the LTE cell further comprises cell-specific information for a group of LTE and/or 5G cells contained within a cell group.

32. The apparatus of claim 31 wherein the cell-specific information includes initial access information for connecting to each cell within the cell group.

33. The apparatus of claim 32 wherein the cell-specific information comprises a cell ID (identification) for each cell within the cell group and cell-specific information associated with each cell ID.

34. The apparatus of claim 32 wherein the cell-specific information comprises one or more lists of cell IDs (identifications) and cell-specific information associated with each list.

35. The apparatus of claim 32 wherein the cell-specific information comprises one or more lists of carrier frequencies and cell-specific information associated with each list.

36. The apparatus of claim 26 wherein the processing circuitry and transceiver are to receive updated system information from the LTE or 5G cell but not apply the updated system information until the start of a next system information modification period.

37. An apparatus for an eNB (evolved Node B), comprising:
a radio transceiver and processing circuitry interfaced to the radio transceiver;
wherein the processing circuitry and transceiver are to:
transmit system information over a cell served by the eNB;
wherein the system information transmitted over the serving cell further comprises system-wide information that is common to a plurality of neighboring cells and cell-specific information for a group of cells contained within a cell group; and,
wherein the cell-specific information for at least two of the cells in the cell group is different.

38. The apparatus of claim 37 wherein the cell-specific information comprises a cell ID (identification) for each cell within the cell group and cell-specific information associated with each cell ID.

39. The apparatus of claim 37 wherein the cell-specific information comprises one or more lists of cell IDs (identifications) and cell-specific information associated with each list.

40. The apparatus of claim 37 wherein the cell-specific information comprises one or more lists of carrier frequencies and cell-specific information associated with each list.

41. The apparatus of claim 37 wherein the cell-specific information includes initial access system information for connecting to each cell within the cell group using a random access procedure.

42. The apparatus of claim 41 wherein at least one of cells in the group for which initial access system information is transmitted is a 5G (fifth generation) cell.

43. The apparatus of claim 41 wherein the processing circuitry and transceiver are to transmit the initial access system information for connecting to the 5G cell via a broadcasted SIB (system information block) or via RRC (radio resource control) after a UE connects with a serving cell of the eNB.

44. The apparatus of claim 41 wherein the transmitted initial access system information includes an MIB (master information block) containing information that includes a DL (downlink) cell bandwidth and control channel configurations, an SIB1 (system information block 1) containing information that includes information relating to access restrictions and time-domain scheduling of an SIB2 (system information block 2).

45. A computer-readable medium comprising instructions to cause a user equipment (UE), upon execution of the instructions by processing circuitry of the UE, to:
receive system information transmitted by an LTE (Long Term Evolution) cell, which system information comprises initial access information for connecting to the LTE cell and for connecting to a 5G (fifth generation) cell using random access procedures; and,
connect to the 5G cell using the system information received from the LTE cell.

46. The medium of claim 45 further comprising instructions to receive the 5G initial access system information for connecting to the 5G cell via an SIB (system information block) broadcasted by the LTE cell.

47. The medium of claim 45 further comprising instructions to receive the 5G initial access system information for connecting to the 5G cell by establishing an RRC (radio resource control) connection with the LTE cell and requesting the system information for connecting to the 5G cell via RRC signaling.

48. The medium of claim 45 wherein the initial access information received from the LTE cell for connecting to the LTE cell and the 5G cell includes an MIB (master information block) containing information that includes a DL (downlink) cell bandwidth and control channel configurations, an SIB1 (system information block 1) containing information that includes information relating to access restrictions and time-domain scheduling of an SIB2 (system information block 2) that includes information relating to random access procedures for connecting to the cell.

49. The medium of claim 45 wherein the system information received from the LTE cell further comprises system-wide information that is common to a plurality of neighboring LTE and/or 5G cells.

50. The medium of claim 45 wherein the system information received from the LTE cell further comprises cell-specific information for a group of LTE and/or 5G cells contained within a cell group.
